(19) United States
(12) Patent Application Publication
(10) Pub. No.: US 2017/0113649 A1
(43) Pub. Date: Apr. 27, 2017

(54) PRETENSIONER HAVING FRACTURE CONNECTION-TYPE RACK GEAR

(71) Applicant: WOOSHIN SAFETY SYSTEMS CO., LTD., Hwaseong-si (KR)

(72) Inventors: Kyung Sang LEE, Anyang-si (KR); Doo Yong KIM, Ansan-si (KR); Jae Hak CHOI, Suwon-si (KR); Jae Hyuk PARK, Yesangun (KR); Se Hun KIM, Busan (KR)

(21) Appl. No.: 15/307,184

(22) PCT Filed: Apr. 23, 2015
(86) PCT No.: PCT/KR2015/004066

§ 371 Date: Oct. 27, 2016

(30) Foreign Application Priority Data
Apr. 29, 2014 (KR) 10-2014-0051771

(51) Int. Cl. B60R 22/46

(52) U.S. Cl. CPC B60R 22/4628

(57) ABSTRACT

A pretensioner having a fracture connection-type rack gear includes: a housing having a receiving space; a pinion gear provided in the receiving space, connected to a rotating shaft of a spool around which a webbing of a seat belt is wound, and rotated by rotation of the spool; a micro gas generator generating explosive power by impact from the outside; a conveying pipe having one side connected with the micro gas generator and the other side having an opening and connected to the receiving space; ball members provided in the conveying pipe, and conveyed toward the receiving space by the explosive power; and a rack gear provided to be fixed into the receiving space by a fixing unit, meshing with the pinion gear when the fixing unit is fractured, and rotating the pinion gear, by residual thrust of the ball members, in a direction in which the webbing is retracted.

### TECHNICAL FIELD

The present invention relates to a pretensioner, and more particularly, to a pretensioner which includes a rack gear that meshes with a pinion gear when a fixing unit is fractured by a plurality of ball members conveyed by explosive power of a gas generator, thereby retracting a webbing.

### BACKGROUND ART

Various safety devices are provided in a vehicle or a machine in order to prevent serious injury or death of an occupant as the occupant is thrown from a driver seat due to a collision between vehicles or a collision with other objects in a state in which the occupant is seated in the vehicle or the machine.

A seat belt is the most representative safety device among the safety devices, and a lower abdomen and a chest of the occupant seated in the vehicle or the machine may be stably secured to the seat by using the seat belt.

However, if an amount of impact, which is generated due to a collision between vehicles or a collision with other objects, is increased to a predetermined level or higher, the occupant is often injured even though the occupant fastens the seat belt, and safety of the occupant seated in the vehicle or the machine is jeopardized in many instances.

Therefore, various technologies are being developed so as to allow the seat belt to exhibit its own function even in a case in which a magnitude of a collision between vehicles or a collision with other objects is large. As a technology which is currently in the limelight inter alia, there is a pretensioner which retracts the webbing of the seat belt at the time of a collision between vehicles or a collision with other objects, thereby improving a function or an effect of the seat belt.

The pretensioner generally moves a rack, which is adjacent to a micro gas generator (MGG), by using driving power generated by the micro gas generator, and rotates a pinion connected with a spool, thereby retracting the webbing wound around the spool.

In this case, because the rack and the pinion are engaged with each other in order to rotate the pinion in accordance with the movement of the rack, strong force is transmitted to the pinion at a point in time at which driving power begins to be initially transmitted from the micro gas generator, and as a result, the pinion is deformed or damaged in some instances. If the pinion is deformed or damaged as described above, there may occur a problem in that the pretensioner cannot stably transmit driving power to the spool.

In addition, the micro gas generator generally uses, as driving power, explosive power, which is obtained by exploding an explosive in the micro gas generator, and if gas generated by the explosion of the explosive is not completely discharged, there may occur a problem in that an overshoot load of an operating load of the webbing occurs when a load limiter operates.

That is, even though the webbing is locked by an emergency locking retractor (ELR) operating part after the pretensioner operates, an operating load of the webbing is applied to the occupant by inertial force, and the operating load of the webbing is continuously increased, and as a result, the occupant is injured.

The load limiter extends the webbing to some extent in order to prevent the injury, but if the gas is not completely discharged from the pretensioner as described above, the gas hinders the movement of the rack, and the rotation of the pinion connected to the spool is also hindered, and as a result, the webbing cannot be extended.

There is a problem in that the hindrance to the extension of the webbing may cause the overshoot load of the operating load of the webbing which is the aforementioned problem that occurs when the load limiter operates.

Accordingly, there is a need for a method for solving the aforementioned problems.

### DISCLOSURE

### Technical Problem

The present invention has been made in an effort to solve the aforementioned problems in the related art, and to provide a pretensioner in which driving power is more stably transmitted from a micro gas generator to a spool.

The present invention has also been made in an effort to provide a pretensioner which prevents the occurrence of an overshoot load of an operating load of a webbing when a load limiter operates.

The present invention has also been made in an effort to provide a pretensioner in which a rack gear smoothly meshes with a pinion gear, thereby improving operational reliability.

Technical problems of the present invention are not limited to the aforementioned technical problems, and other technical problems, which are not mentioned above, may be clearly understood by those skilled in the art from the following descriptions.

### Technical Solution

To achieve the aforementioned objects, a pretensioner having a fracture connection-type rack gear according to the present invention includes: a housing which has a receiving space; a pinion gear which is provided in the receiving space, connected to a rotating shaft of a spool around which a webbing of a seat belt is wound, and rotated in accordance with a rotation of the spool; a micro gas generator which generates explosive power in accordance with impact from the outside; a conveying pipe which has one side that is connected with the micro gas generator, and the other side that has an opening and is connected to the receiving space; a plurality of ball members which is provided in the conveying pipe, and conveyed toward the receiving space by the explosive power of the micro gas generator; and a rack gear which is provided to be fixed into the receiving space by a fixing unit, meshes with the pinion gear when the fixing unit is fractured by the ball members conveyed toward the receiving space by the explosive power of the micro gas generator, and rotates the pinion gear, by residual thrust of the ball members, in a direction in which the webbing is retracted.

Further, the rack gear may be elongated in a longitudinal direction, one side of the rack gear may be positioned in a direction toward the opening of the conveying pipe, and the fixing unit may include a first fixing member which fixes one side of the rack gear and is fractured by the ball members, and a second fixing member which fixes the other side of the rack gear, defines a rotation axis of the rack gear in a state in which the first fixing member is fractured, and is fractured when the rack gear is moved in a state in which the rack gear meshes with the pinion gear.

In addition, the rack gear may be formed in a curved shape, and the pretensioner may further include a rotating roller which is provided in the receiving space, rotates by coming into contact with the rack gear when the second fixing pin is fractured, and assists the movement of the rack gear.

Further, the rack gear may further include a protrusion portion which protrudes so that the ball member is caught by the protrusion portion.

In addition, the housing may include a guide portion which guides the movement of the ball members that are conveyed toward the receiving space by the explosive power of the micro gas generator.

Further, the rack gear may be formed in a curved shape, and the guide portion may be formed to have a curvature corresponding to that of the rack gear.

In addition, when the rack gear meshes with the pinion gear and moves a predetermined distance, the rack gear may be spaced apart from the opening of the conveying pipe at a predetermined distance so as to define a leak region, and the ball member may be withdrawn through the leak region.

Further, an expanded opening, which is connected with the opening and increases an area of the leak region, may be formed around the other side of the conveying pipe.

### Advantageous Effects

The pretensioner having the fracture connection-type rack gear according to the present invention, which is made to solve the aforementioned problems, has the following effects.

First, there is an advantage in that driving power may be stably transmitted from the micro gas generator to the spool.

Second, there is an advantage in that since the plurality of ball members is used to transmit explosive power generated by the micro gas generator to the rack gear, the rack gear may smoothly mesh with the pinion gear, thereby greatly improving operational reliability.

Third, there is an advantage in that since the ball member may be withdrawn after the rack gear moves a predetermined distance, an overshoot load of an operating load of the webbing is not generated when a load limiter operates.

Fourth, there is an advantage in that an overall size of the device may be reduced.

The effects of the present invention are not limited to the aforementioned effects, and other effects, which are not mentioned above, will be clearly understood by those skilled in the art from the claims.

### DESCRIPTION OF DRAWINGS

FIG. 1 is a perspective view illustrating an appearance of a seat belt retractor having a pretensioner according to an exemplary embodiment of the present invention.

FIG. 2 is an exploded perspective view illustrating connection structures between components of the seat belt retractor having the pretensioner according to the exemplary embodiment of the present invention.

FIG. 3 is a cross-sectional view illustrating an internal structure of the pretensioner according to the exemplary embodiment of the present invention.

FIG. 4 is a cross-sectional view illustrating a state in which ball members are conveyed by explosion of a micro gas generator in the pretensioner according to the exemplary embodiment of the present invention.

FIG. 5 is a cross-sectional view illustrating a state in which the ball members are conveyed by explosion of the micro gas generator and fracture a first fixing member of a rack gear in the pretensioner according to the exemplary embodiment of the present invention.

FIG. 6 is a cross-sectional view illustrating a state in which the rack gear meshes with a pinion gear in the pretensioner according to the exemplary embodiment of the present invention.

FIG. 7 is a cross-sectional view illustrating a state in which a second fixing member is fractured by the movement of the rack gear in the pretensioner according to the exemplary embodiment of the present invention.

FIG. 8 is a cross-sectional view illustrating a state in which the rack gear comes into contact with a rotating roller in the pretensioner according to the exemplary embodiment of the present invention.

FIG. 9 is a cross-sectional view illustrating a state in which the rack gear is moved by residual thrust of the ball members in the pretensioner according to the exemplary embodiment of the present invention.

FIG. 10 is a cross-sectional view illustrating a state in which the ball member is withdrawn through a leak region in the pretensioner according to the exemplary embodiment of the present invention.

### BEST MODE

Hereinafter, an exemplary embodiment of the present invention by which the aforementioned object can be specifically achieved will be described with reference to the accompanying drawings. In the description of the present exemplary embodiment, like terms and like reference numerals are used for like components, and additional descriptions will be omitted.

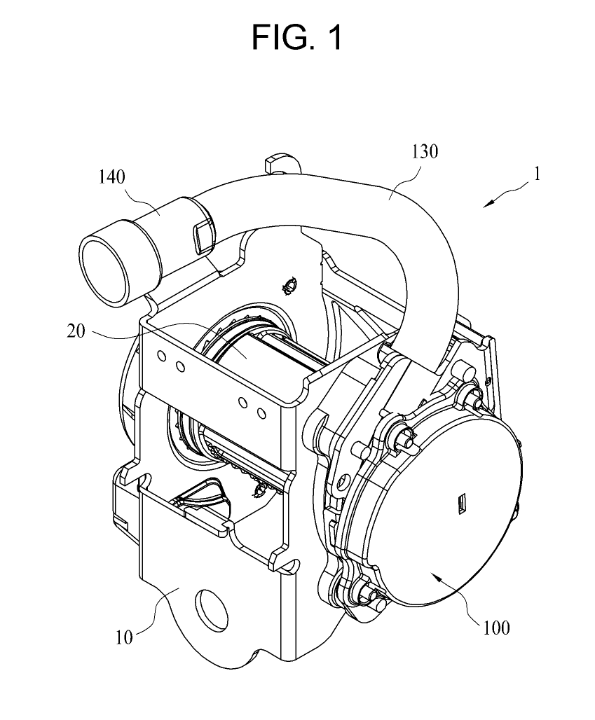

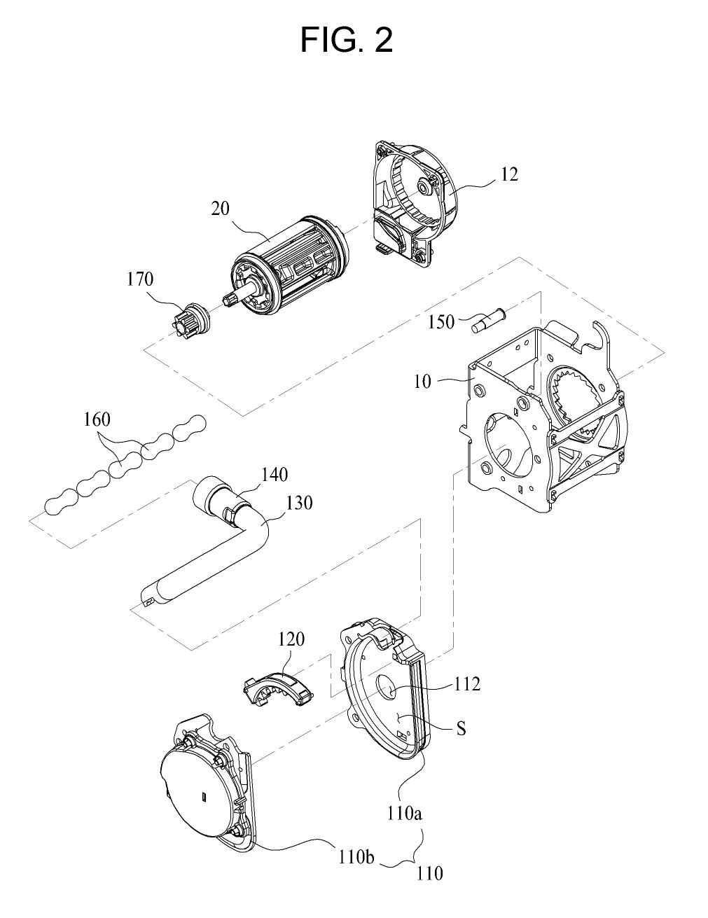

FIG. 1 is a perspective view illustrating an appearance of a seat belt retractor 1 having a pretensioner 100 according to an exemplary embodiment of the present invention, and FIG. 2 is an exploded perspective view illustrating connection structures between components of the seat belt retractor 1 having the pretensioner 100 according to the exemplary embodiment of the present invention.

As illustrated in FIGS. 1 and 2, the seat belt retractor 1 includes a frame 10, and a spool 20 which is rotatably provided on the frame 10 so as to wind or unwind a webbing (not illustrated).

In addition, a cover 12 is provided at one side of the frame 10, and a pretensioner 100 is provided at the other side of the frame 10. Further, the pretensioner 100 includes a housing 110, a pinion gear 170, a micro gas generator 140, a conveying pipe 130, ball members 160, and a rack gear 120. Further, in the present exemplary embodiment, a rotating roller 150 may be further included in addition to the aforementioned constituent elements.

Referring to FIG. 2, the housing 110 includes a base housing 110a and a cover housing 110b, and a receiving space S is formed between the base housing 110a and the cover housing 110b. Further, the pinion gear 170 is inserted into the receiving space S through a through hole 112 of the housing 110 in a state in which the pinion gear 170 is connected to a rotating shaft of the spool 20.

In this state, the rack gear 120 and the rotating roller 150 are accommodated in the receiving space S, one side of the conveying pipe 130 is connected with the micro gas generator 140, and the other side of the conveying pipe 130 has an opening and is connected to the receiving space S. Further, the plurality of ball members 160 is provided and accommodated in the conveying pipe 130.

The connection structures between the respective constituent elements have been described above, and hereinafter, the respective constituent elements will be described in more detail.

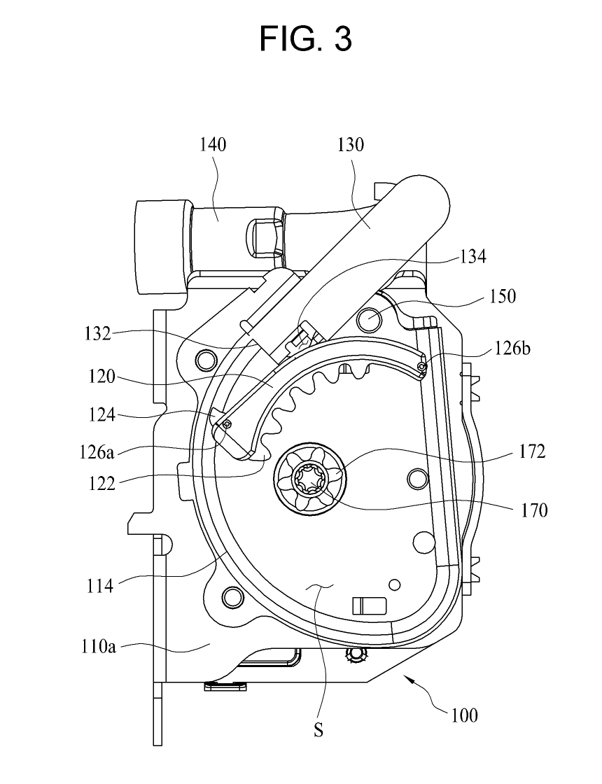

FIG. 3 is a cross-sectional view illustrating an internal structure of the pretensioner 100 according to the exemplary embodiment of the present invention.

As described above, the pretensioner 100 according to the present exemplary embodiment includes the housing 110 which includes the base housing 110a and the cover housing 110b (see FIG. 2), the pinion gear 170, the micro gas generator 140, the conveying pipe 130, the ball members 160 (see FIG. 2), the rack gear 120, and the rotating roller 150.

The housing 110 has the receiving space S which accommodates other constituent elements, and in the present exemplary embodiment, the housing 110 includes a guide portion 114 which guides the movement of the ball members 160 that are conveyed toward the receiving space S by explosive power of the micro gas generator 140 to be described below. As the guide portion 114 guides the ball member 160, the guide portion 114 defines a movement route of the rack gear 120, and the movement route will be described below.

The pinion gear 170 is provided in the receiving space S, and connected to the rotating shaft of the spool 20 (see FIG. 2) around which the webbing of the seat belt is wound, such that the pinion gear 170 is rotated together with the spool 20 in accordance with the rotation of the spool 20.

That is, when the spool 20 is rotated in a direction in which the webbing is retracted, the pinion gear 170 is rotated in the same direction as the spool 20, and when the spool 20 is rotated in a direction in which the webbing is extended, the pinion gear 170 is also rotated in the same direction as the spool 20.

In the present exemplary embodiment, the webbing is retracted when the pinion gear 170 is rotated counterclockwise based on FIG. 3, and the webbing is extended when the pinion gear 170 is rotated clockwise based on FIG. 3.

Further, a plurality of gear teeth 172 is provided on the pinion gear 170, and may mesh with gear teeth 122 formed on the rack gear 120.

The micro gas generator 140 is a constituent element which generates explosive power by impact from the outside.

Further, one side of the conveying pipe 130 is connected with the micro gas generator 140, and the other side of the conveying pipe 130 has the opening 132 and is connected to the receiving space S. Further, the plurality of ball members 160 (see FIG. 2), which is conveyed toward the receiving space S by explosive power of the micro gas generator 140, is provided in the conveying pipe 130.

That is, when impact is applied from the outside to an object such as a vehicle in which the pretensioner 100 is installed, an explosive provided in the micro gas generator 140 generates explosive power, and the explosive power may be transmitted to the ball members 160 provided in the conveying pipe 130. For this reason, the ball members 160 may be conveyed toward the rack gear 120 in the receiving space S.

The rack gear 120 is provided to be fixed into the receiving space S by a fixing unit. Further, the fixing unit is fractured by the ball members 160, which is conveyed toward the receiving space S by the explosive power of the micro gas generator 140, and as a result, the rack gear 120 may mesh with the pinion gear 170.

That is, the rack gear 120 is initially fixed into the receiving space S in a state in which the rack gear 120 is not coupled to the pinion gear 170, and the fixing unit is fractured by kinetic energy of the ball members 160 caused by the impact from the outside, and as a result, the rack gear 120 is coupled to the pinion gear 170. Further, the pinion gear 170 may be rotated by residual thrust of the ball members 160 in the direction in which the webbing is retracted.

In the present exemplary embodiment, the rack gear 120 is elongated in longitudinal direction, and formed in a curved shape. Specifically, one side of the rack gear 120 is positioned in a direction toward the opening 132 of the conveying pipe 130, and the other side of the rack gear 120 extends to a predetermined position in the receiving space S.

Further, in the present exemplary embodiment, the fixing unit includes a first fixing member 126a and a second fixing member 126b.

The first fixing member 126a is a constituent element which fixes one side of the rack gear 120 and is fractured by the ball members 160.

In addition, the second fixing member 126b fixes the other side of the rack gear 120 and defines a rotation axis of the rack gear 120 immediately after the first fixing member 126a is fractured. Thereafter, when the rack gear 120 is moved in a state in which the rack gear 120 meshes with the pinion gear 170, the second fixing member 126b is also fractured, and the rack gear 120 is released from the fixed state.

Further, when the second fixing member 126b is fractured, the rotating roller 150 rotates by coming into contact with the rack gear 120, and thus may assist the movement of the rack gear 120 having a curved shape.

Meanwhile, the rack gear 120 further includes a protrusion portion 124 which protrudes so that the ball member 160 is caught by the protrusion portion 124, and as a result, the rack gear 120 may be conveyed together with the ball members 160 while the ball members 160 are being conveyed by the residual thrust.

The respective constituent elements of the pretensioner 100 according to the exemplary embodiment of the present invention has been described above, and hereinafter, processes in which the pretensioner 100 operates will be described in detail.

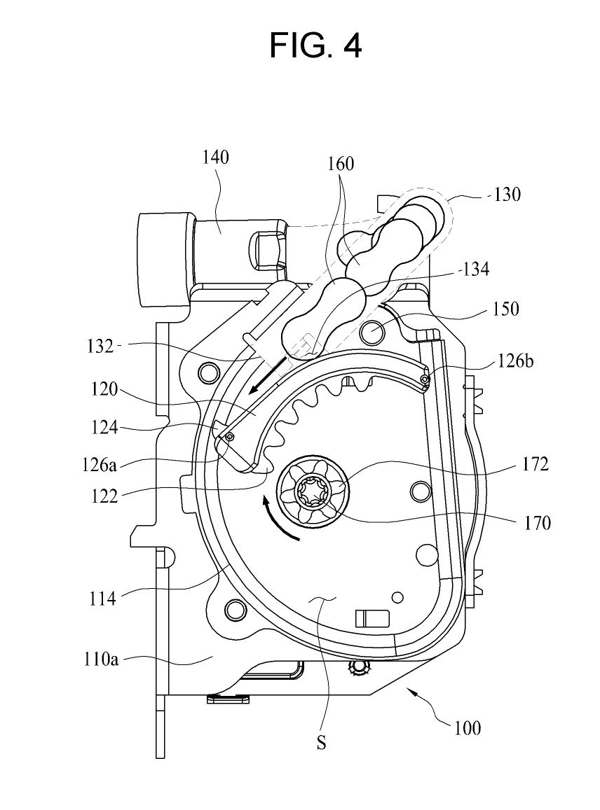

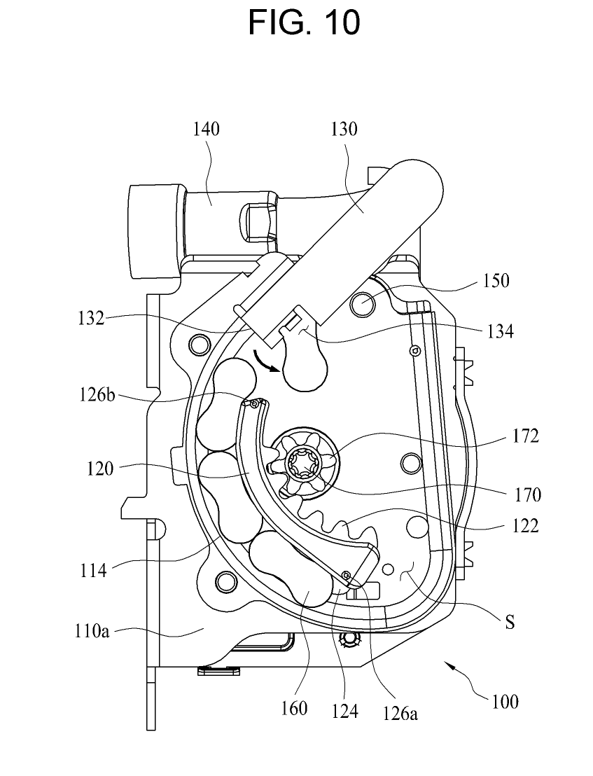

FIGS. 4 to 10 are views illustrating processes, for each period of time, in which the pretensioner 100 according to the exemplary embodiment of the present invention operates when impact occurs in the vehicle or the like.

First, referring to FIG. 4, when impact occurs in an object such as the vehicle in which the pretensioner 100 according to the exemplary embodiment of the present invention is provided, force which intends to move a driver forward is generated by inertia, and as a result, the webbing is extended. Further, the pinion gear 170 begins to be rotated clockwise, that is, in the direction in which the webbing is extended. If this situation is maintained, the driver may be severely injured.

Therefore, when impact is applied from the outside, the micro gas generator 140 generates explosive power by an explosive provided in the micro gas generator 140.

Therefore, the explosive power is transmitted to the plurality of ball members 160 provided in the conveying pipe 130, and the plurality of ball members 160 is sequentially and quickly discharged toward the receiving space S through the opening 132 of the conveying pipe 130.

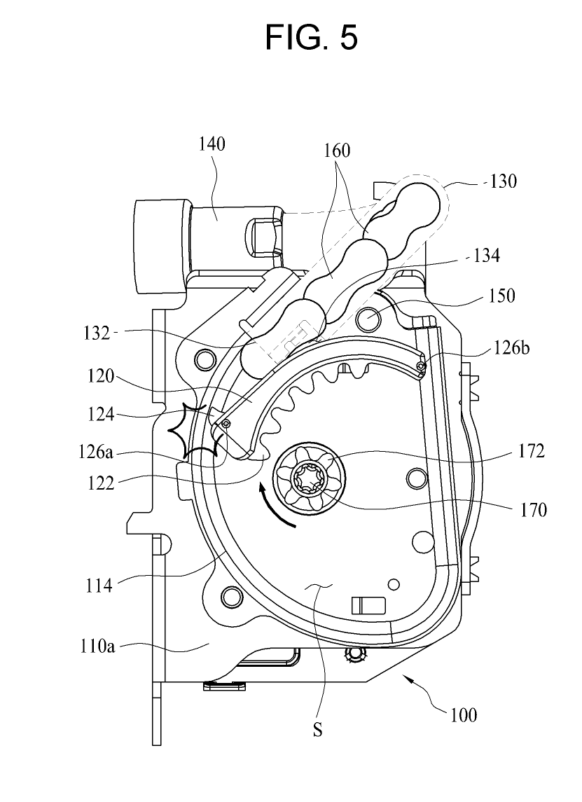

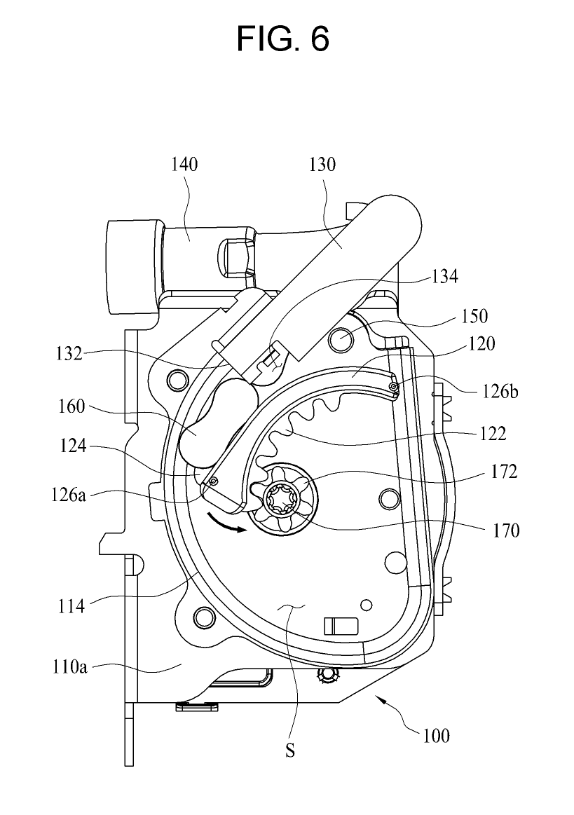

Further, as illustrated in FIG. 5, the discharged ball members 160 are moved toward the rack gear 120, and the first fixing member 126a is fractured by kinetic energy caused by the movement of the discharged ball members 160. Thereafter, as illustrated in FIG. 6, the rack gear 120 is rotated about the second fixing member 126b as a rotation axis, and thus meshes with the pinion gear 170. Therefore, the pinion gear 170, which is being rotated in the direction in which the webbing is extended, stops rotating.

In this case, the process in which the rack gear 120 meshes with the pinion gear 170 is very quickly carried out from a point in time at which the impact is applied from the outside, and as a result, it is possible to minimize the forward inertial movement of the driver and prevent the webbing from being extended.

Further, even after the ball members 160 fracture the first fixing member 126a, the residual thrust is generated by the micro gas generator 140, and as a result, the rack gear 120 receives external force in a direction in which the ball member 160 are conveyed.

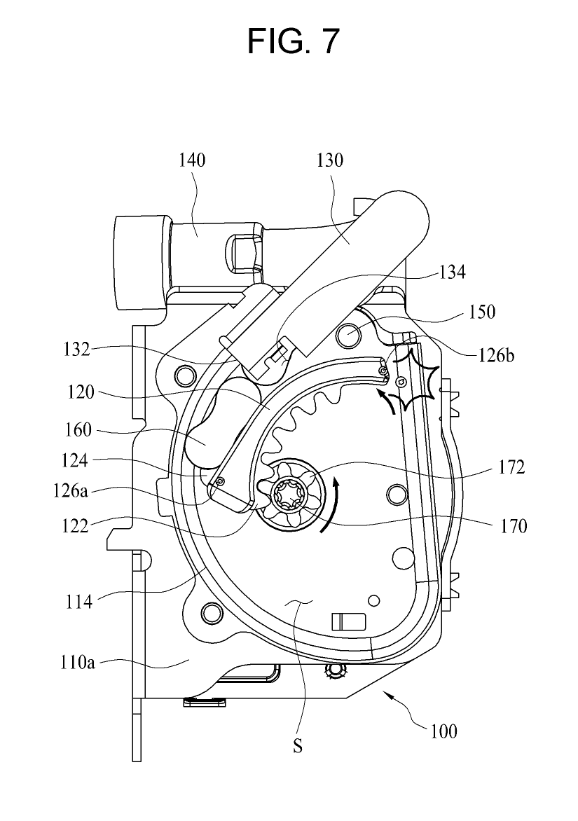

Therefore, as illustrated in FIG. 7, the rack gear 120 is conveyed by the residual thrust of the ball members 160 and rotates the pinion gear 170 counterclockwise, that is, in the direction in which the webbing is retracted, and in this process, the second fixing member 126b is fractured.

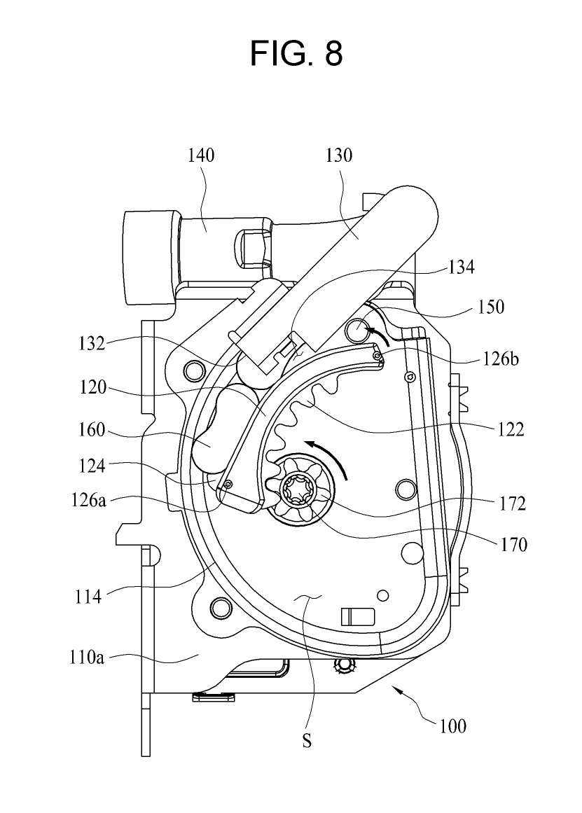

The fixed state of the rack gear 120 is released, such that the rack gear 120 is conveyed together with the ball members 160 by the residual thrust of the ball members 160. In this case, as illustrated in FIG. 8, the other side of the rack gear 120 comes into contact with the rotating roller 150, the rotating roller 150 is rotated, and the ball members 160 push the protrusion portion 124 of the rack gear 120, such that the rack gear 120 may be smoothly conveyed.

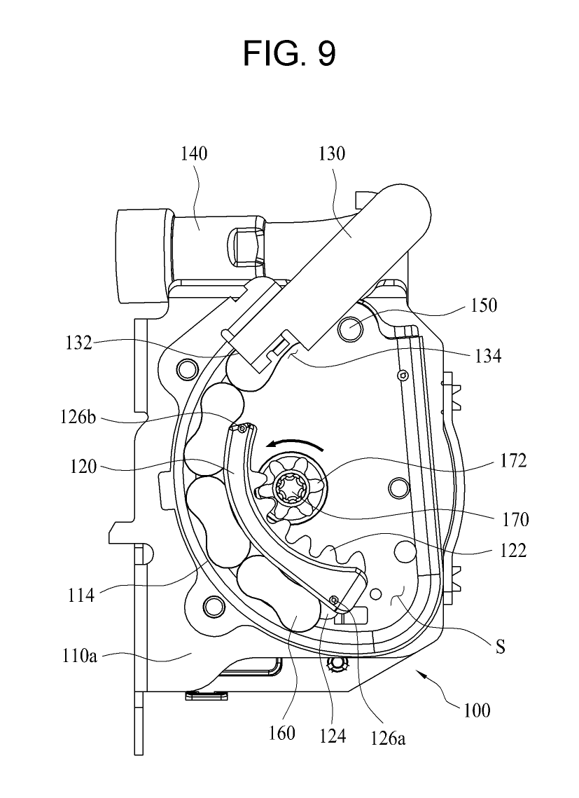

Further, as illustrated in FIG. 9, the ball members 160 are conveyed along the guide portion 114 formed on the base housing 110a, and the rack gear 120 is conveyed together with the ball members 160 in a direction in which the thrust is provided, thereby rotating the pinion gear 170 counterclockwise. Therefore, the webbing is retracted, thereby preventing the driver with the fastened seat belt from being thrown from the seat.

Meanwhile, because the aforementioned method has a limitation in still preventing the driver from being thrown from the seat, a seat belt retractor locks the webbing so that the webbing is not further extended. The webbing is slightly extended because a load is still applied to the occupant in the vehicle due to inertia even after the webbing is locked as described above, and in this case, if the extension of the webbing is hindered, the continuously applied load may increase the severity of injury of the driver.

Therefore, it is necessary to extend the webbing to some extent by using a load limiter, but the extension of the webbing may be hindered in a state in which the ball members 160 continuously apply the thrust to the rack gear 120 as described above.

Therefore, in the present exemplary embodiment, when the rack gear 120 meshes with the pinion gear 170 and moves a predetermined distance, the rack gear 120 may be spaced apart from the opening 132 of the conveying pipe 130 at a predetermined distance and may define a leak region, and in this case, the ball member 160 is withdrawn through the leak region.

That is, after the rack gear 120 rotates the pinion gear 170 to some extent in the direction in which the webbing is retracted, a separation space is formed between the other side of the rack gear 120 and the conveying pipe 130, and the separation space defines the leak region through which the ball member 160 is withdrawn.

Further, when the ball member 160 is withdrawn through the leak region, the residual thrust applied to the rack gear 120 is eliminated, and as a result, the webbing is extended through the load limiter, thereby reducing the amount of load applied to the driver.

Meanwhile, in the present exemplary embodiment, an expanded opening 134, which is connected with the opening 132 and increases an area of the leak region, is further formed around the other side of the conveying pipe 130. The expanded opening 134 may form the leak region even though the separation distance between the other side of the rack gear 120 and the conveying pipe 130 is not sufficiently ensured, thereby withdrawing the ball members 160.

Therefore, in this case, there is an advantage in that the device may be further miniaturized.

While the exemplary embodiment according to the present invention has been described above, it is obvious to those skilled in the art that the present invention may be specified in other particular forms in addition to the aforementioned exemplary embodiment without departing from the spirit or the scope of the present invention. Accordingly, it should be understood that the aforementioned exemplary embodiment is regarded as illustrative and not restrictive, and thus the present invention is not limited to the aforementioned description, and may be modified within the scope and the equivalent range of the appended claims.

1. A pretensioner comprising:
a housing which has a receiving space;
a pinion gear which is provided in the receiving space, connected to a rotating shaft of a spool around which a webbing of a seat belt is wound, and rotated in accordance with a rotation of the spool;
a micro gas generator which generates explosive power in accordance with impact from the outside;
a conveying pipe which has one side that is connected with the micro gas generator, and the other side that has an opening and is connected to the receiving space;
a plurality of ball members which is provided in the conveying pipe, and conveyed toward the receiving space by the explosive power of the micro gas generator; and
a rack gear which is provided to be fixed into the receiving space by a fixing unit, meshes with the pinion gear when the fixing unit is fractured by the ball members conveyed toward the receiving space by the explosive power of the micro gas generator, and rotates the pinion gear, by residual thrust of the ball members, in a direction in which the webbing is retracted.

2. The pretensioner of claim 1, wherein the rack gear is elongated in a longitudinal direction, one side of the rack gear is positioned in a direction toward the opening of the conveying pipe, and the fixing unit includes a first fixing member which fixes one side of the rack gear and is fractured by the ball members, and a second fixing member which fixes the other side of the rack gear, defines a rotation axis of the rack gear in a state in which the first fixing member is fractured, and is fractured when the rack gear is moved in a state in which the rack gear meshes with the pinion gear.

3. The pretensioner of claim 2, wherein the rack gear is formed in a curved shape, and the pretensioner further includes a rotating roller which is provided in the receiving space, rotates by coming into contact with the rack gear when the second fixing member is fractured, and assists the movement of the rack gear.

4. The pretensioner of claim 1, wherein the rack gear further includes a protrusion portion which protrudes so that the ball member is caught by the protrusion portion.

5. The pretensioner of claim 1, wherein the housing includes a guide portion which guides the movement of the ball members that are conveyed toward the receiving space by the explosive power of the micro gas generator.

6. The pretensioner of claim 5, wherein the rack gear is formed in a curved shape, and the guide portion is formed to have a curvature corresponding to that of the rack gear.

7. The pretensioner of claim 1, wherein when the rack gear meshes with the pinion gear and moves a predetermined distance, the rack gear is spaced apart from the opening of the conveying pipe at a predetermined distance so as to define a leak region, and the ball member is withdrawn through the leak region.

8. The pretensioner of claim 7, wherein an expanded opening, which is connected with the opening and increases an area of the leak region, is formed around the other side of the conveying pipe.
